(19) United States
(12) Patent Application Publication
(10) Pub. No.: US 2026/0072806 A1
(43) Pub. Date: Mar. 12, 2026

(54) SYSTEM AND METHOD FOR AUTOMATED QUALITY ASSESSMENT AND EVALUATION FOR LARGE LANGUAGE MODELS

(71) Applicant: Kabushiki Kaisha Toshiba, Tokyo (JP)

(72) Inventors: Carlos Adrian Sanchez MOMPO, Bristol (GB); Aftab KHAN, Bristol (GB)

(73) Assignee: Kabushiki Kaisha Toshiba, Tokyo (JP)

(21) Appl. No.: 18/882,418

(22) Filed: Sep. 11, 2024

(51) Int. Cl. G06F 11/34

(52) U.S. Cl. CPC G06F 11/3414

(57) ABSTRACT

Systems and methods for automated assessment of one or more language models is described herein. A method can comprise: generating, using a first language model and based at least in part on an input prompt, a plurality of criterion candidates for evaluating an output from the language model(s); ranking, using a second language model, the plurality of criterion candidates a first time, thereby producing a first set of ranks; after producing the first set of ranks, ranking, using the second language model, the plurality of criterion candidates a second time after the first time, thereby producing a second set of ranks; determining, based on the first set of ranks and the second set of ranks, at least one assessment metric to evaluate the output from the language model(s); and evaluating, based at least in part on the at least one assessment metric, a performance of the language model(s).

### TECHNICAL FIELD

The present disclosure relates generally to the field of large language models. In particular, this disclosure relates to automated quality assessment and evaluation for large language models.

### BACKGROUND

A large language model (LLM) is a type of artificial intelligence model that is trained to recognize, predict, translate, or generate text or other content. Generally, LLMs utilize neural network architectures called transformer networks that are configured to track relationships in sequential data. Transformer networks enable the LLMs to learn context and meaning from the sequential data. This allows LLMs to process and generate language sequences efficiently. Popular LLMs include general-purpose LLMs such as for example, generative pre-trained transformer (GPT) models (e.g., ChatGPT that was developed by OpenAI™).

General-purpose LLMs are trained on vast datasets and are configured to perform a wide range of language tasks. While general-purpose LLMs may advantageously perform a wide range of tasks, there are several challenges associated with using general-purpose LLMs. First, the costs associated with general-purpose LLMs may be high. For example, given the vast data requirements, general-purpose LLMs can have high computing needs and cloud costs. Second, owing to the size of these LLMs are trained to perform, these general-purpose LLMs are often associated with high latency. Third, general-purpose LLMs are not fine-tuned to perform specific tasks. Thus, the performance of general-purpose LLMs for specific tasks may be inconsistent. Given these challenges of general-purpose LLMs, there has been an increase in demand for edge-based LLMs that are trained to perform specific tasks. These edge-based LLMs are customized for specific tasks. These edge-based custom LLMs have lower resource requirements and lower latency in comparison to general-purpose LLMs. With the rise in the number of these custom networks, there is a need for an efficient process to train and evaluate these custom LLMs.

Conventionally, LLMs are trained and evaluated manually. Put differently, human intervention or human supervision is required to pre-train, fine-tune, and/or evaluate LLMs. For instance, generally, LLMs are fine-tuned using datasets that are crafted by humans. Similarly, human assessors evaluate outputs from a LLM given an input prompt. More specifically, some existing methods utilize pre-existing datasets to test and evaluate performance (e.g., by evaluating outputs from a LLM) of a LLM. Other existing methods utilize human assessors to generate criterions to evaluate performance (e.g., by evaluating outputs from a LLM) of a LLM. Human supervision and/or human intervention can make the process of training, fine-tuning, or evaluating LLMs laborious and costly. Additionally, such manual processes can lead to inconsistencies owing to human error and oversight.

Accordingly, there is a need to fully automate the process of fine-tuning a LLM and evaluating a LLM’s performance for performing a specific task without the need for human intervention or without the need for pre-existing datasets.

### BRIEF DESCRIPTION OF THE DRAWINGS

FIG. 1A depicts a first example existing method for evaluating a large language model.

FIG. 1B depicts a second example existing method for evaluating a large language model.

FIG. 1C depicts a third example existing method for evaluating a large language model.

FIG. 1D depicts a fourth example existing method for evaluating a large language model.

FIG. 2 illustrates an example variation of a system for automated quality assessment and evaluation of one or more large language models.

FIG. 3 illustrates an example input prompt and example input data.

FIG. 4 is a flowchart depicting an example method that can be implemented by the assessment metric generator module to automatically generate one or more assessment metrics so as to evaluate one or more large language models.

FIG. 5 illustrates example criterion candidates generated by the systems and method described herein.

FIG. 6 illustrates an example modified input prompt.

FIG. 7 is a flowchart depicting an example method that can be implemented by the training module to automatically generate a fine-tuned custom language model.

FIG. 8A is a flowchart depicting an example method that can be implemented by the dataset generator module to automatically generate a first dataset that can be used to evaluate a performance of the one or more large language models.

FIG. 8B is a flowchart depicting an example method that can be implemented by the dataset generator module to automatically generate a second dataset that can be used to evaluate a performance of the one or more large language models.

FIG. 9 is a flowchart depicting a high-level overview of an example method that can be implemented by the quality assessor module to automatically evaluate a performance of one or more large language models.

FIG. 10 illustrates an example output 1038 generated by a large language model.

FIG. 11 illustrates example assessment metrics and example scores generated for these assessment metrics via the quality assessor module.

FIG. 12 illustrates example outputs that are generated by two large language models.

FIG. 13 illustrates example assessment metrics and example winners determined via the quality assessor module.

FIG. 14 illustrates an example variation of a method for generating assessment metric(s) for evaluating a large language model, fine-tuning a large language model, and evaluating performance of a large language model.

### DETAILED DESCRIPTION

Non-limiting examples of various aspects and variations of systems and methods for automated assessment of one or more language models is described herein. In particular, described herein are end-to-end automated systems and methods that (without human intervention) can automatically one or more of: a) generate assessment metrics for evaluating one or more language models; b) fine-tune one or more language models; and/or c) evaluate performance of one or more language models.

As used herein, the term “language model” or “large language model” generally refers to computational models that are configured to implement natural language understanding and natural language processing capabilities. These models may include a transformer architecture (e.g., a transformer encoder, a transformer decoder, etc.), one or more attention layers, one or more recurrent layers, and one or more embedding layers. “Language models” or “large language models” can be trained to encode input (e.g., input in the form of speech or text) that the model receives, and generate output predictions (e.g., predicting the next word or next token) so as to perform a language task.

As used herein, the term “general-purpose language model” generally refers to a “large language model” that is trained on extensive datasets to perform a wide range of language tasks. More specifically, “general-purpose language models” are not trained to perform a specific task. Instead, these language models are pre-trained on diverse datasets such as for example, text from the Internet, so as to perform a wide range of language tasks (e.g., generate human-like text, answer questions, compose emails, summarize passages, create content in various styles and formats, etc.). Non-limiting examples of a “general-purpose language model” include generative pre-trained transformer (GPT) models (e.g., ChatGPT that was developed by OpenAI™).

As used herein, the term “custom language model” generally refers to a “large language model” that is pre-trained to perform one or more specific tasks. “Custom language models” are generally trained on domain specific datasets. Consequently, these language models have profound understanding of terminology, context, and subtle nuances within a particular field. Therefore, these language models may provide more precise and tailored responses to the one or more specific tasks.

As used herein, the term “input prompt” generally refers to a set of instructions or a query that is given to a “large language model”. The “input prompt” is configured to guide the large language model to generate a specific response or output. In particular, the “input prompt” can act as a catalyst for the large language model’s language generation capabilities. Additionally, the “input prompt” can be configured to direct the language model’s focus to a particular task, question, or topic. In some variations, the “input prompt” may be a simple prompt (e.g., a prompt that includes direct questions for the language model to answer and/or direct questions for the language model to output to the user). In other variations, the “input prompt” may include complex scenarios (e.g., multiple situations for the large language model to consider before generating an output). The “input prompt” can be configured to guide the large language model to infer, deduce, and/or create content. In some variations, the effectiveness of the “input prompt” may directly influence the relevance and accuracy of a large language model’s response.

As used herein, the term “input data” generally refers to data that accompanies and/or is included in an “input prompt”. The “input data” provides necessary contextual information to enable the large language model to perform the specific task(s). The “input data” can be diverse. For example, the “input data” may include background information, specific details, parameters, datasets, and/or the like that may define the scope of the specific task(s). As an example, if the specific task is a task to write an essay on a historical event, the “input prompt” may include a set of instructions to guide the large language model to write the essay, and the “input data” may include dates, key figures, and significant occurrences that may be related to the historical event. The quality of the “input data” may affect the quality of the output from the large language model. For instance, the quality of the “input data” may affect the large language model’s ability to produce coherent, informed, and tailored outputs.

As discussed above, existing technologies require human intervention to fine-tune large language models and evaluate performance (e.g., by evaluating outputs from the large language models) of large language models. In particular, existing technologies use human supervisors to generate datasets for evaluating large language models and/or use human assessors to evaluate outputs from large language models.

According to an embodiment, there is provided a computer-implemented method for automated assessment of one or more language models. The method comprises generating, using a first language model and based at least in part on an input prompt, a plurality of criterion candidates for evaluating an output from the one or more language models. The first language model is a general-purpose generative language model. The method further comprises ranking, using a second language model, the plurality of criterion candidates a first time, thereby producing a first set of ranks. The method further comprises after producing the first set of ranks, ranking, using the second language model, the plurality of criterion candidates a second time after the first time, thereby producing a second set of ranks. The method further comprises determining, based on the first set of ranks and the second set of ranks, at least one assessment metric to evaluate the output from the one or more language models, and evaluating, based at least in part on the at least one assessment metric, a performance of the one or more language models.

In some variations, the one or more language models comprises a third language model, the method further comprises: automatically modifying the input prompt to generate a modified input prompt, fine-tuning, using the modified input prompt, the third language model to produce a fine-tuned third language model, and evaluating, based on the at least one assessment metric, a performance of the fine-tuned third language model. The modified input prompt can be configured to improve token efficiency of the third language model. The third language model can be a specialized model that is trained to perform a specific task.

In some variations, the at least one assessment metric comprises a plurality of assessment metrics. Evaluating the performance further includes: for each assessment metric of the plurality of assessment metrics: generating a score based on whether an output from the fine-tuned third language model satisfies the assessment metric, and evaluating the performance of the fine-tuned third language model based on the

In some variations, the one or more language models further comprise a fourth language model. The method further comprises: comparing an output from the fourth language model and an output from the fine-tuned third language model, and evaluating the performance of the fine-tuned third language model based on the comparison. The output from the fourth language model can be generated in response to providing the input prompt to the fourth language model. The output from the fine-tuned third language model can be generated in response to providing the modified input prompt to the fine-tuned third language model.

In some variations, the method further includes: determining a winner based on whether the output from the fine-tuned third language model satisfies the at least one assessment metric or on whether the output from the fourth language model satisfies the at least one assessment metric, and evaluating the performance of the fine-tuned third language model and the fourth language model based on the determined winner. In some variations, the first language model and the fourth language model are a same model.

In some variations, the method further comprises outputting a decision to deploy the one or more language models based on the evaluation of the performance of the one or more language models.

In some variations, the method further comprises: after producing the second set of ranks, ranking, using the second language model, the plurality of criterion candidates a third time after the second time, thereby producing a third set of ranks; and determining the at least one assessment metric based on the first set of ranks, the second set of ranks, and the third set of ranks.

According to an embodiment, there is provided a system for automated assessment of one or more language models. The system comprises at least one controller configured to execute an assessment metric generator module and a quality assessor module. The assessment metric generator module can be configured to: generate, using a first language model and based at least in part on an input prompt, a plurality of criterion candidates for evaluating an output from the one or more language models, rank, using a second language model, the plurality of criterion candidates a first time, thereby producing a first set of ranks, after producing the first set of ranks, rank, using the second language model, the plurality of criterion candidates a second time after the first time, thereby producing a second set of ranks, and determine, based on the first set of ranks and the second set of ranks, at least one assessment metric to evaluate the output from the one or more language models. The first language model can be a general-purpose generative language model. The quality assessor module can be configured to evaluate, based at least in part on the at least one assessment metric, a performance of the one or more language models.

In some variations, the one or more language models comprises a third language model. The at least one controller can be further configured to execute: a prompt modifier module to automatically modify the input prompt to generate a modified input prompt, the modified input prompt being configured to improve token efficiency of the third language model, a training module to fine-tune, using the modified input prompt, the third language model to produce a fine-tuned third language model, wherein the third language model is a specialized model that is trained to perform a specific task, and the quality assessor module to evaluate, based on the at least one assessment metric, a performance of the fine-tuned third language model.

In some variations, the at least one assessment metric comprises a plurality of assessment metrics. The assessment metric generator module can be further configured to: for each assessment metric of the plurality of assessment metrics: generate a score based on whether an output from the fine-tuned third language model satisfies the assessment metric, wherein the quality assessor module is further configured to evaluate the performance of the fine-tuned third language model based on the generated scores.

In some variations, the one or more language models further comprise a fourth language model. The quality assessor module can be further configured to: compare an output from the fourth language model and an output from the fine-tuned third language model and evaluate the performance of the fine-tuned third language model based on the comparison. The output from the fourth language model can be generated in response to providing the input prompt to the fourth language model. The output from the fine-tuned third language model can be generated in response to providing the modified input prompt to the fine-tuned third language model

In some variations, the quality assessor module can be further configured to: determine a winner based on whether the output from the fine-tuned third language model satisfies the at least one assessment metric or on whether the output from the fourth language model satisfies the at least one assessment metric, and evaluate the performance of the fine-tuned third language model and the fourth language model based on the determined winner. In some variations, the first language model and the fourth language model can be a same model.

In some variations, the quality assessor module can be further configured to output a decision to deploy the one or more language models based on the evaluation of the performance of the one or more language models. In some variations, the assessment metric generator module is further configured to: after producing the second set of ranks, rank, using the second language model, the plurality of criterion candidates a third time after the second time, thereby producing a third set of ranks; and determine the at least one assessment metric based on the first set of ranks, the second set of ranks, and the third set of ranks.

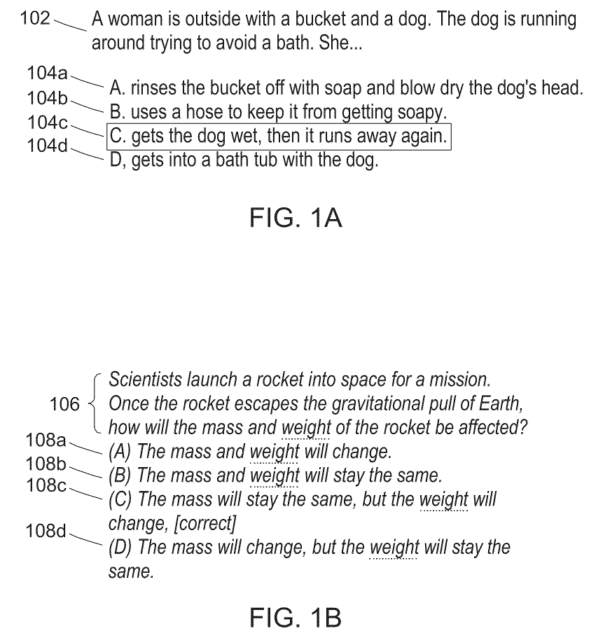

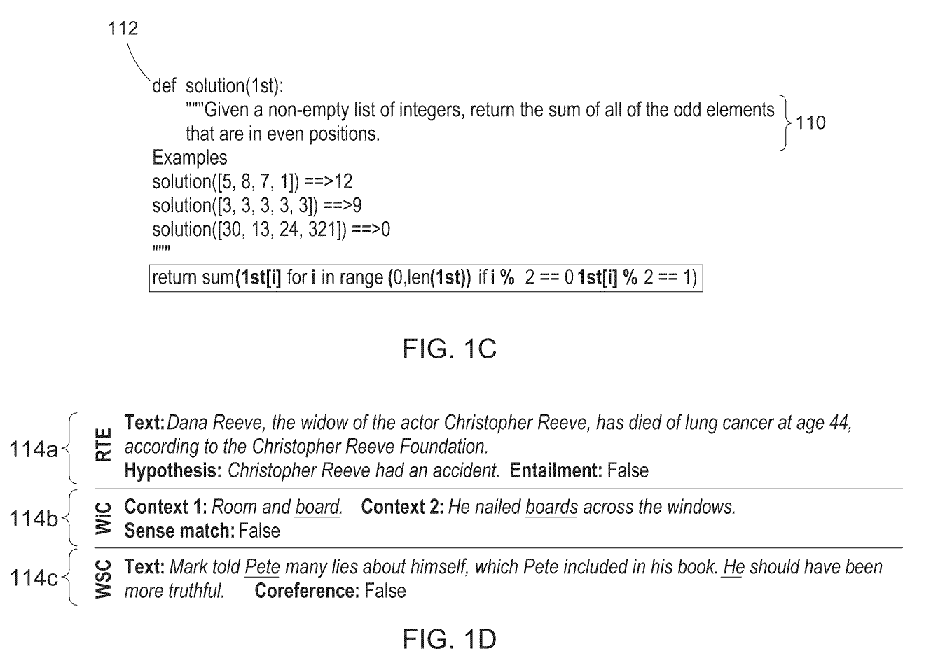

FIG. 1A illustrates a first existing example method, ARC (https://www.semanticscholar.org/paper/Think-you-have-Solved-Question-Answering-Try-ARC%2C-Clark-Cowhey/88bb0a28bb58d847183ec505dda89b63771bb495), for evaluating the performance of large language models. ARC comprises posing a question and/or providing a reasoning challenge to the large language models. For instance, in FIG. 1A, reasoning challenge 102 is provided to a large language model. ARC further comprises providing a series of options to the large language models as a possible answer to the reasoning challenge and/or the question. In FIG. 1A, a series of options 104a, 104b, 104c, and 104d are provided to the large language model as a possible answer to reasoning challenge 102. The large language model is instructed to select an answer (e.g., by selecting the correct option, outputting a letter corresponding to the correct answer, etc.) from 104a, 104b, 104c, and 104d as the answer to the reasoning challenge 102. The performance of the large language model is evaluated based on the answer that the large language model selects to the reasoning challenge 102. In this example, the large language model selects option 104d as an answer to the reasoning challenge 102. However, for ARC, the reasoning challenge (e.g., 102) and the series of options (e.g., 104a-104d including the correct answer 104c) are crafted by humans. Since the questions/reasoning challenge and the series of options are crafted by humans, this method for evaluating large language models can be costly and laborious.

FIG. 1B illustrates a second example method, HellaSwag (https://arxiv.org/pdf/1905.07830) for evaluating the performance of large language models. Similar to ARC (i.e., the first example method discussed in relation to FIG. 1A), this method comprises providing a question 106 and a series of options 108a, 108b, 108c, and 108d to the large language model. The performance of the large language model is evaluated based on the answer that the large language model selects. The question 106 and the series of options 108a-108d are crafted by humans, thereby making this method for evaluating large language models costly and laborious.

FIG. 1C illustrates a third example method, HumanEval (https://arxiv.org/pdf/2107.03374v2) for evaluating the performance of large language models. In particular, HumanEval is configured to evaluate a large language model’s ability to write software programs (e.g., computer code). More specifically, HumanEval is configured to evaluate the correctness of a software program (e.g., that is written by a large language model). In order to evaluate, a large language model is provided with a description of a task that the software program is to perform. The description of the task is provided as a comment and a function. For example, in FIG. 1C, the description of a task that a software program is to perform is provided as a comment 110 and a function 112. The comment (e.g., comment 110) and the function (e.g., function 112) are crafted by humans. Therefore, this method for evaluating a large language model’s ability to write software programs is costly and laborious.

FIG. 1D illustrates a fourth example method, SuperGLUE (https://w4ngatang.github.io/static/ papers/superglue.pdf) for evaluating the performance of large language models. This method comprises providing a variety of challenges based on reasoning and context understanding to the LLM. For example, in FIG. 1D, the large language model is provided with challenges 114a, 114b, and 114c. These challenges are crafted by humans, thereby making this method laborious and costly,

As seen in these existing methods, a human-in-the-loop approach is required to evaluate performance of the large language models. For example, these methods require generation of human-verified examples of outcomes in order to evaluate performance of large language models. Unlike these existing methods, embodiments described herein fully automate the process of evaluating a large language model’s performance for one or more tasks without the need for human intervention or without the need for pre-existing datasets. At a high level, embodiments described herein can automatically generate one or more assessment metrics (e.g., criterions for evaluation) for evaluating the performance of large language models (e.g., ability of the large language models to precisely perform one or more specific tasks). For example, embodiments described herein can automatically generate one or more assessment metrics based on the input prompt that is associated with the specific task that a large language model is to perform. In some variations, in addition to the input prompt, the one or more assessment metrics are generated based on the input data. Additionally or alternatively, embodiments described herein can automatically fine-tune a custom language model. For example, embodiments described herein can automatically generate one or more datasets to fine-tune a large language model. Additionally or alternatively, embodiments described herein can automatically evaluate the performance of large language models. For instance, embodiments described herein can evaluate the performance of a large language model for a given input prompt (and in some variations, for a given input data). In some variations, embodiments described herein can individually evaluate the performance of one or more large language models. Additionally or alternatively, embodiments described herein can perform comparative evaluation of the performance of two or more large language models. For example, embodiments described herein can perform comparative evaluation of the performance of a general-purpose large language model and the performance of a custom large language model. Accordingly, compared to the existing technologies, embodiments described herein can be fully automated. Therefore, embodiments described herein can reduce inconsistencies that arise from manual processes, is less laborious, and is computationally more efficient.

### EXAMPLE SYSTEM

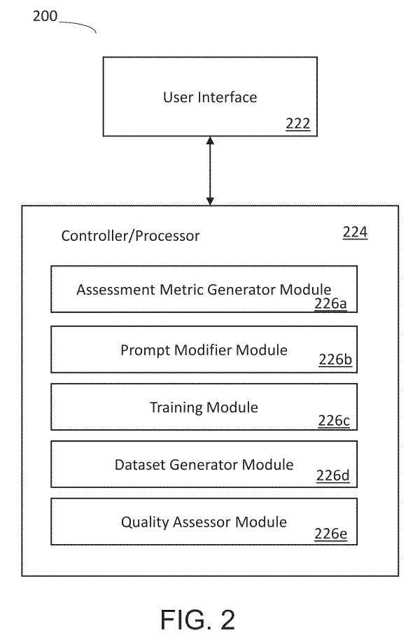

FIG. 2 illustrates an example variation of a system 200 for generating assessment metric(s) for evaluating a large language model, fine-tuning a large language model, and evaluating performance of a large language model. The system 200 includes a user interface 222 that is configured to obtain as input: (a) information identifying one or more large language models that is to be evaluated; (b) an input prompt to be provided to the one or more large language models to perform one or more specific tasks. In some variations, the input prompt may be accompanied by and/or may include input data to provide contextual information to the large language models.

The input received at the user interface 222 may be in any suitable format (e.g., text, audio, images, videos, numbers, a combination thereof, and/or the like). In some examples, the user interface 222 may be rendered on any suitable computing device. Some non-limiting examples of computing device include computers (e.g., desktops, personal computers, laptops, etc.), tablets and e-readers (e.g., Apple iPad®, Samsung Galaxy® Tab, Microsoft Surface®, Amazon Kindle®, etc.), mobile devices and smart phones (e.g., Apple iPhone®, Samsung Galaxy®, Google Pixel®, etc.), etc. The computing device may be communicatively coupled to a controller 224 via a network (e.g., Internet, Local Area Network (LAN), Wider Area Network (WAN), and/or the like).

The user interface 222 can be communicably coupled to a controller 224. In some variations, the controller 224 may include one or more servers and/or one or more processors running on a cloud platform (e.g., Microsoft Azure®, Amazon® web services, IBM® cloud computing, etc.). The server(s) and/or processor(s) may be any suitable processing device configured to run and/or execute a set of instructions or code, and may include one or more data processors, image processors, graphics processing units, digital signal processors, and/or central processing units. The server(s) and/or processor(s) may be, for example, a general purpose processor, a Field Programmable Gate Array (FPGA), an Application Specific Integrated Circuit (ASIC), and/or the like.

In some variations, controller 224 may include a processor (e.g., CPU). The processor may be any suitable processing device configured to run and/or execute a set of instructions or code, and may include one or more data processors, image processors, graphics processing units, physics processing units, digital signal processors, and/or central processing units. The processor may be, for example, a general purpose processor, a Field Programmable Gate Array (FPGA), an Application Specific Integrated Circuit (ASIC), and/or the like. The processor may be configured to run and/or execute application processes and/or other modules, processes and/or functions associated with the system and/or a network associated therewith. The underlying device technologies may be provided in a variety of component types (e.g., MOSFET technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, and/or the like.

In some examples, the controller 224 can be configured to implement one or more modules to: a) automatically generate assessment metrics, b) automatically fine-tune a custom large language model, c) automatically generate one or more datasets to be evaluated, and/or d) automatically evaluate one or more language models. The one or more modules can include an assessment metric generator module 226a, a prompt modifier module 226b, a training module 226c, a dataset generator module 226d, and/or a quality assessor module 226e.

The controller 224 (e.g., the processor of the controller) may include instructions and/or software code to execute the modules 226a-226e. In some examples, the processor may execute all the modules 226a-226e. In some examples, the instructions and/or software code may include separate calls to separate modules 226a-226e. A call to one module may redirect the processing performed by the controller 224 to implement instructions included in that module. Following the execution of that module, if the instructions and/or software code include a call to another module, then the processing may be redirected to implement instructions included in the other module. In some examples, the controller 224 may execute each module 226a-226e in a series one after another. Alternatively, the controller 224 may execute two or more modules simultaneously. In some examples, two or more modules may be combined into a single module. These modules 226a-226e and their functions are described in detail below.

### Assessment metric generator module

The assessment metric generator module 226a can be configured to automatically generate one or more assessment metrics to evaluate one or more large language models. More specifically, the assessment metric generator module 226a can be configured to generate a plurality of criterion candidates for evaluating outputs from one or more large language models. The one or more assessment metrics can be determined from the generated plurality of criterion candidates. The one or more assessment metrics can provide a measure for the stability and coherence of custom language models being evaluated.

The plurality of criterion candidates can be generated based on the input prompt. In some variations, in addition to the input prompt, the plurality of criterion candidates can also be generated based on the input data. In variations in which the criterion candidates are generated based on the input prompt and the input data, in some instances, a same input data may be used to generate each of the plurality of criterion candidates. In other instances, different input data may be used to generate at least some of the plurality of criterion candidates. As a simple non-limiting example for illustrative purposes, consider an input prompt “instructions1”, a first input data “data1”, and a second input data “data2”. A first criterion candidate may be generated based on “instructions1” and “data1” while a second criterion candidate may be generated based on “instructions1” and “data2”. Alternatively, both the first criterion candidate and the second criterion candidate may be generated based on “instructions1” and “data1”. In yet another alternative variation, both the first criterion candidate and the second criterion candidate may be generated based on “instructions1” and “data2”.

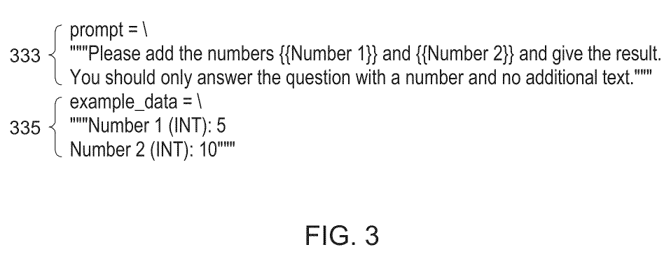

FIG. 3 illustrates an example input prompt 333 and example input data 335. As discussed above, the input prompt 333 guides a large language model to perform a specific task. For instance, in this example, the input prompt 333 guides a large language model to add two numbers (e.g., {Number 1} and {Number 2}) and provide the result. As seen in the example, the input prompt 333 provides further guidance to the large language model on how to output the answer (e.g., with a number and no additional text). The input data 335 provides contextual information so that the large language model can perform the specific task. For instance, in this example, the input data 335 provides {Number 1} and {Number 2} (e.g., “5” and “10”) for the large language model to add.

The assessment generator module 226a can be configured to generate a plurality of criterion candidates based on the input prompt 333 (and in some variations the input data 335). The generated plurality of criterion candidates may evaluate the ability of a large language model to perform a specific task (e.g., in this example, evaluate the ability of the large language model to add {Number 1} and Number 2}, output the result of this addition, not provide any additional text, etc.).

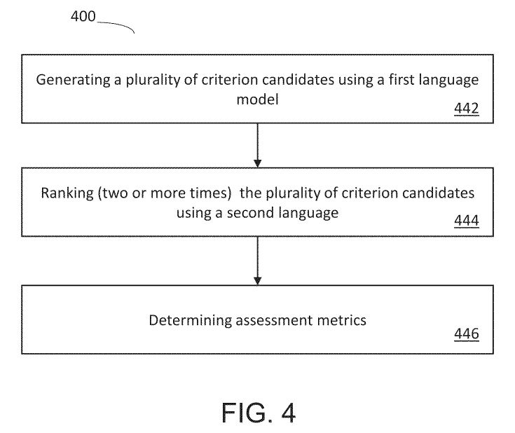

FIG. 4 is a flowchart depicting an example method 400 that can be implemented by the assessment metric generator module 226a to automatically generate one or more assessment metrics so as to evaluate one or more large language models. At step 442, the method includes generating, using a first language model and based at least in part on an input prompt (e.g., input prompt 333 in FIG. 3), a plurality of criterion candidates for evaluating an output from the one or more language models. In some variations, the first language model can be a general-purpose language model, such as for example, a generative pre-trained transformer (GPT) model (e.g., ChatGPT that was developed by OpenAI™). More specifically, at step 442, a general-purpose generative pre-trained transformer (GPT) model may be provided with a set of instructions to generate a plurality of criterion candidates that can evaluate how well a large language model is performing a specific task. The set of instructions may include the input prompt that guides a large language model that is being evaluated to perform the specific task. As an example, the general-purpose GPT model may be provided with a set of instruction to generate a plurality of criterion candidates for evaluating an output from a large language model given the input prompt 333 in FIG. 3. In some variations, in addition to the input prompt, the first language model may also be provided with input data. For instance, in this example, the general-purpose GPT model may also be provided with input data 335 in FIG. 3. Put simply, the instructions to the general-purpose GPT model may include instructions to generate a plurality of criterion candidates that can evaluate an output from a large language model when the large language model is provided with the input prompt “Please add numbers {{Number 1}} and {{Number 2}} and give the result. You should only answer the question with a number and no additional text” and with the input data “Number 1: 5; Number 2: 10”. Accordingly, the general-purpose GPT model can generate a plurality of criterion candidates.

As discussed above, while each of plurality of criterion candidates can be generated based on this same input data, in some variations, different input data may be used to generate different plurality of criterion candidates. For example, the general-purpose GPT model may be instructed to generate a first criterion candidate based on input data “Number 1: 5; Number 2: 10”, a second criterion candidate based on a different input data such as for example, “Number 1: 7; Number 2: 4”, a third criterion candidate based on still different input data such as for example, “Number 1: 5; Number 2: 5”, etc.

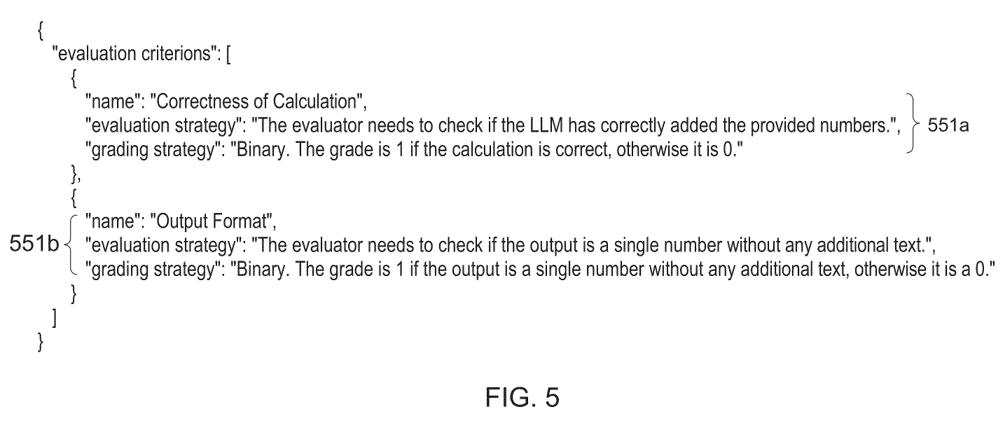

FIG. 5 illustrates example criterion candidates that are generated by a general-purpose GPT model given the input prompt 333 in FIG. 3. For instance, for the input prompt 333 in FIG. 3, the general-purpose GPT model generates a first evaluation criterion 551a to check if the large language model has correctly added the provided numbers and a second evaluation criterion 551b to check if the output is a single number without any additional text. In this manner, the assessment metric generator module can generate a plurality of criterion candidates to evaluate an output from a large language model.

Referring back for FIG. 4, after the plurality of criterion candidates are generated, at step 444, the method includes ranking, using a second language model, the plurality of criterion candidates. In some variations, the second language model may be a general-purpose generative pre-trained transformer (GPT) model. In some variations, the second language model and the first language model may be a same model. Put differently, a same language model may be used to generate the plurality of criterion candidates and rank the plurality of criterion candidates. This is because generally as further discussed below, large language models are stochastic in nature. These language models may not remember previous outputs that were generated.

In some variations, the plurality of criterion candidates can each comprise a list of criteria. Each of these lists can be ranked. An ideal criterion list may comprise lowest number of criteria while simultaneously providing highest coverage of individualized instructions (e.g., instructions in the input prompt). This eliminates overlap of coverage but ensures that the subtleties of the instructions are taken into account. In some variations, ranking may include comparing each of the plurality of criterion candidates based on how well these criterion candidates evaluate a performance of a large language model. The comparison may be based on a clarity, a conciseness, and/or an objectiveness of each of the plurality of criterion candidates as further discussed below.

At step 444, the ranking may be performed more than one time so as to mitigate the stochastic nature of the second language model. Put differently, large language models (especially, general-purpose GPT models) may not necessarily be deterministic in nature. That is, the output from these large language models may not always be deterministic. Accordingly, performing the ranking more than one time may enable improving the accuracy for determining the one or more assessment metrics. Additionally, ranking more than one time may enable the removal of outliers. This further facilitates the second language model to determine the most suitable assessment metric(s).

As an example, a set of instructions may be provided to the second language model to rank the plurality of criterion candidates a first time. This may produce a first set of ranks. After generating the first set of ranks, the set of instructions may be provided to the second language model to rank the plurality of criterion candidates a second time after the first time. This may produce a second set of ranks. This can be repeated a third time, a fourth time, a fifth time, and/or any suitable number of times. The ranking may be based on a clarity, a conciseness, and/or an objectiveness of the criterion candidate. For instance, the set of instructions provided to the second language model may include instructions to rank the plurality of criterion candidates based on their clarity, conciseness, and/or objectiveness.

At step 446, the method includes determining one or more assessment metrics based on the ranking. In some variations, the one or more assessment metrics may be determined based on an average of the ranks or the set of ranks that are generated at step 444. For example, if the ranking in step 444 has been performed two times, then the one or more assessment metrics may be determined based on an average of the first set of ranks and the second set of ranks. Similarly, if the ranking in step 444 has been performed three times, then the one or more assessment metrics may be determined based on an average of the first set of ranks, the second set of ranks, and the third set of ranks. In this manner, by ranking the plurality of criterion candidates more than one time and by determining the assessment metric(s) based on these rankings (e.g., average of the rankings), the accuracy of determining the assessment metric(s) can be improved.

The outputs from the assessment metric generator module 226a may comprise the one or more assessment metrics determined via the assessment metric generator module 226a. In some variations, these one or more assessment metrics may be transmitted to the user interface 222 for outputting via the user interface 222. Additionally or alternatively, these one or more assessment metrics may be provided as input to other modules (e.g., quality assessor module 226e) described herein. In some variations, the output from the assessment metric generator module 226a may also include the plurality of criterion candidates generated via the assessment metric generator module 226a. In some variations, the outputs from the assessment metric generator module 226a may be stored in a database (not shown in FIG. 2).

### Prompt Modifier Module

As discussed above, embodiments described herein can automatically fine-tune a custom language model. The prompt modifier module 226b can be configured to facilitate the fine-tuning of a custom language model. In particular, the prompt modifier module 226b can be configured to automatically modify an input prompt to generate a modified input prompt. In variations in which the input prompt is accompanied with and/or includes input data, the prompt modifier module 226 can be configured to modify the input prompt based on the input data to generate a modified input prompt.

The modified input prompt can be used to fine-tune a custom language model. Fine-tuning the custom language model with the modified input prompt can improve the token efficiency of the custom language model. Generally, the text in input prompts, input data, and/or modified input prompts are represented as tokens. These tokens are received as inputs at the large language models. The large language models process these input tokens to generate output predictions and perform language tasks. In some variations, modifying the input prompt can include eliminating unnecessary instructions from the input prompt and/or unnecessary data from the input data that accompanies the input prompt. The modified input prompt may retain just the necessary instructions to guide the custom language model and the necessary input data to provide contextual information to the custom language model so as to perform a specific task. Therefore, by modifying the input prompt, the length of the input tokens to generate output predictions may be reduced, thereby improving token efficiency. This in turn can lower the computation time of the custom language model, as well as improve the throughput, latency, and efficiency of the custom language model.

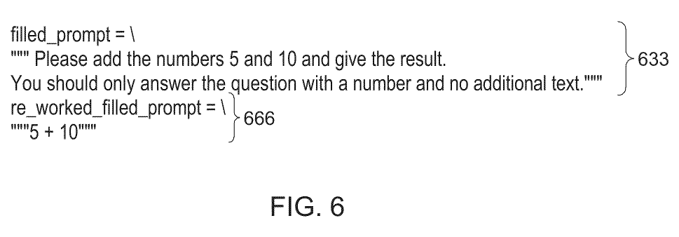

FIG. 6 illustrates an example modified input prompt 666. More specifically, the input prompt 633 in FIG. 6 is modified (e.g., via the prompt modifier module 226b) to generate the modified input prompt 666. In this example, the input prompt 633 “Please add the numbers 5 and 10 and give the result. You should only answer the question with a number and no additional text” is modified to generate modified prompt 666 which is simply “5+10”. As seen in FIG. 6, unnecessary information and/or data may be eliminated from the input prompt and input data to generate the modified input prompt.

Modifying the input prompt to remove unnecessary information and/or data to generate a modified input prompt for a custom language model is possible because unlike a general-purpose language model, a custom language model may be trained to perform a specific task. Therefore, unlike a general-purpose language model, the custom language model may not need elaborate instructions or data to perform that specific task.

The outputs from the prompt modifier module 226b may comprise the modified input prompt. In some variations, the modified input prompt may be transmitted to the user interface 222 for outputting via the user interface 222. Additionally or alternatively, the modified input prompt may be provided as input to other modules (e.g., training module 226c) described herein. In some variations, the outputs from the prompt modifier module may be stored in a database (not shown in FIG. 2).

### Training Module

The training module 226c can be configured to fine-tune the custom language model, thereby producing a fine-tuned custom language model. As noted above, the custom language model is pre-trained to perform a specific task. The training module 226c can be configured to fine-tune the pre-trained custom language model. Generally, the size of a general-purpose language model can be large, since such models are trained to perform a wide variety of tasks. In contrast, the size of a custom language model can be significantly smaller. For example, the custom language model may have fewer parameters than a general-purpose language model. Fine-tuning the custom language model can align the custom language model with the specific task that the model is pre-trained to perform without losing the knowledge that the model may have acquired during pre-training. More specifically, fine-tuning may comprise training the pre-trained custom language model using the modified input prompt to adjust the parameters of the pre-trained custom language model to better perform the specific task. In this example, the training module 226c may fine-tune the custom language model using the modified input prompt generated by the prompt modifier module 226b.

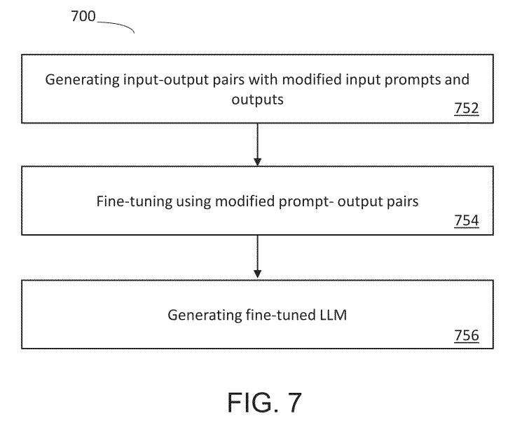

FIG. 7 is a flowchart depicting an example method 700 that can be implemented by the training module 226c to automatically generate a fine-tuned custom language model. At step 752, the method comprises generating input-output pairs of data comprising pairs of modified input prompt generated by the prompt modifier module 226b and a corresponding output from another language model. In some variations, this other language model may be the same as the first language model described above. In some variations, this other language model can be a general-purpose language model (e.g., GPT model). More specifically, an input prompt (e.g., input prompt 633 in FIG. 6) is provided to a general-purpose language model (e.g., general-purpose generative pre-trained transformer (GPT) model). Responsive to being provided with the input prompt, the general-purpose language model may generate an output. The input prompt is modified via the prompt modifier module 226b to generate a modified input prompt (e.g., modified input prompt 666 in FIG. 6). The modified input prompt can be associated with the output generated by the general-purpose language model (responsive to being provided with the input prompt) to form a pair of data. In this manner, input-output pairs comprising the modified input prompt and a corresponding output from the general-purpose language model can be generated. In some variations, the modified input prompt and the output generated by the general-purpose language model (responsive to being provided with the input prompt) can be formatted to a pre-defined format. In particular, the input-output pairs are formatted to a pre-defined format. The pre-defined format may be a pre-defined instruction-answer format, a pre-defined question-answer format, or a pre-defined user-agent format, etc.

At step 754, the pairs of data generated at step 752 can be used to fine-tune the custom language model. For example, the data generated at step 752 can be used to perform a supervised fine-tuning. The fine-tuning may further align the custom language model with its corresponding specific task. As an example, consider an example custom language model that is pre-trained to add two number. Fine-tuning may enable this custom language model to add two numbers and generate an output in a correct format (e.g., as required by the specific task) and with a correct answer. In some variations, after fine-tuning the custom language model, the method may further comprise performing direct preference optimization (DPO) or proximal policy optimization (PPO) reward training. The fine-tuning of the custom language model and size minimization can be through quantization and/or other techniques such as sparsification. In particular, the weights of the fine-tuned custom language model can be quantized or sparsified to simplify the computations that the model is to perform and to reduce the size of the custom language model.

After fine-tuning the custom language model, at step 756, the method comprises generating and/or producing a fine-tuned custom language model. In this manner, the training module 226c can be configured to generate a fine-tuned custom language model.

The outputs from the training module 226c may comprise the fine-tuned custom language model. In some variations, the fine-tuned custom language model may be transmitted to one or more edge devices such as for example, phones, edge gateways, cloud server, 5G ORAN, and/or the like. In some variations, the output may comprise an indication that the custom language model has been fine-tuned. This indication may be transmitted to the user interface 222 for outputting to the user. In some variations, the fine-tuned custom language model outputted by the training module 226c may be used by other modules (e.g., dataset generator module 226d) described herein.

### Dataset Generator Module

The dataset generator module 226d can be configured to automatically generate datasets that can be used to evaluate a performance (e.g., given an input prompt, how well does a large language model perform a specific task) of one or more large language models. To evaluate the performance, the dataset generator module 226d can generate two types of datasets – a first dataset that is generated using the fine-tuned custom language model and a second dataset that is generated using a fourth language model.

### Generating the first dataset

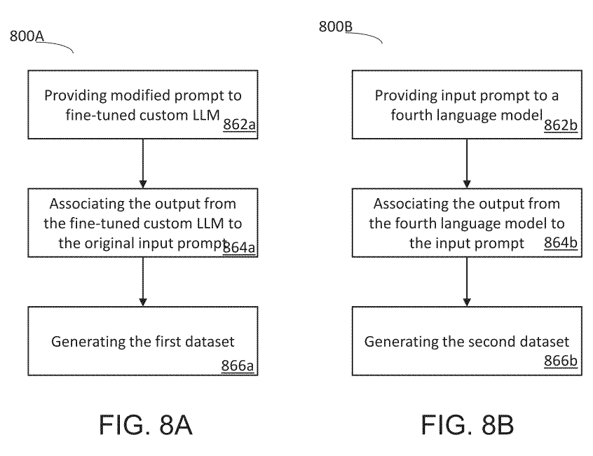

FIG. 8A is a flowchart depicting an example method 800A that can be implemented by the dataset generator module 226d to automatically generate a first dataset that can be used to evaluate a performance of the one or more large language models. At step 862a, the method comprises after producing the fine-tuned custom language model (e.g., at step 756 in FIG. 7), providing a modified input prompt (e.g., generated via the prompt modifier module 226b) to the fine-tuned custom language model. As discussed above, the modified input prompt (e.g., modified input prompt 666 in FIG. 6) can be generated by modifying an input prompt (e.g., input prompt 633 in FIG. 6). Responsive to being provided with the modified input prompt, the fine-tuned custom language model may generate an output.

At step 864a, the method comprises associating the output from the fine-tuned custom language model (i.e., output that is generated responsive to providing the modified input prompt to the fine-tuned custom language model) with the input prompt (i.e., the original un-modified input prompt). In particular, this step comprises generating a pair of data that comprises: (1) output that is generated in response to the fine-tuned custom language model being provided with the modified input prompt; and (2) the input prompt.

At step 866a, the method comprises generating a first dataset. The first dataset can comprise a plurality of pairs of data. Each pair of the plurality of pairs of data can be generated in step 864a. Put differently, each pair of data that is generated in step 864a may be assembled together to form the first dataset. In this manner, the dataset generator module 226d can generate the first dataset. In some variations, the first dataset can be used to evaluate a performance of one or more language models. For example, the first dataset can be used to evaluate the performance of the fine-tuned custom language model.

### Generating the second dataset

FIG. 8B is a flowchart depicting an example method 800B that can be implemented by the dataset generator module 226d to automatically generate a second dataset that can be used to evaluate a performance of the one or more large language models. At step 862b, the method comprises providing an input prompt (e.g., input prompt 633 in FIG. 6) to a fourth language model. In some variations, the fourth language model may be a same model as the first language model described above. In some variations, the fourth language model can be a general-purpose language model (e.g., GPT model). Put differently, the input prompt can be provided to the general-purpose language model. Responsive to being provided with the input prompt, the fourth language model (e.g., general-purpose language model) may generate an output.

At step 864b, the method comprises associating the output from the fourth language model (i.e., output that is generated responsive to providing the input prompt to the fourth language model) with the input prompt (i.e., the original un-modified input prompt). In particular, this step comprises generating a pair of data that comprises: (1) output that is generated in response to the fourth language model being provided with the input prompt; and (2) the input prompt.

At step 866b, the method comprises generating a second dataset. The second dataset can comprise a plurality of pairs of data. Each pair of the plurality of pairs of data can be generated in step 864b. Put differently, each pair of data that is generated in step 864b may be assembled together to form the second dataset. In this manner, the dataset generator module 226d can generate the second dataset. In some variations, the second dataset can be used to evaluate a performance of one or more language models. For example, the second dataset can be used to evaluate the performance of the fine-tuned custom language model and/or the performance of the fourth language model.

The outputs from the dataset generator module 226d may comprise the first dataset and/or the second dataset. The first dataset and/or the second dataset may be provided as input to other modules (e.g., quality assessor module 226e) described herein. In some variations, the first dataset and/or the second dataset may be stored in a database (not shown in FIG. 2).

### Quality Assessor Module

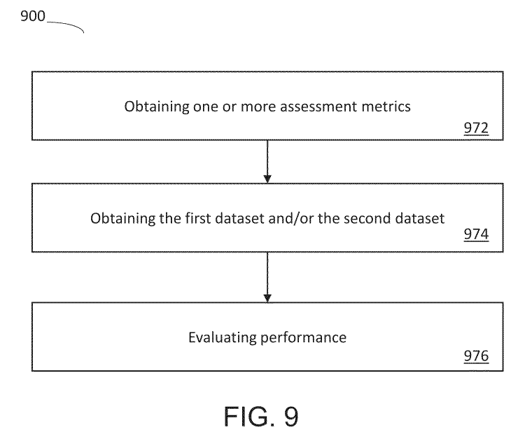

The quality assessor module 226e can be configured to automatically evaluate one or more language models. FIG. 9 is a flowchart depicting a high-level overview of an example method 900 that can be implemented by the quality assessor module 226e to automatically evaluate a performance (e.g., given an input prompt, how well does a large language model perform a specific task) of one or more large language models. At step 972, the method comprises obtaining one or more assessment metrics. In some variations, these assessment metric(s) may have been generated via the assessment metric generator module 226a. In such variations, the assessment metric(s) can be obtained from the assessment metric generator module 226a. As discussed above, for a given input prompt, the one or more assessment metrics can evaluate a large language model’s ability to perform a specific task.

At step 974, the method comprises obtaining a first dataset and/or a second dataset. The first dataset may include an output from a fine-tuned custom language model (e.g., generated at step 756 in FIG. 7). The output from the fine-tuned custom language model can be generated responsive to providing the modified input prompt (e.g., generated via the prompt modifier module 226b) to the fine-tuned custom language model. The second dataset may include an output from the fourth language model discussed above. The output from the fourth language model can be generated responsive to providing the input prompt to the fourth language model. As discussed above, in some variations, the fourth language model may be a same model as the first language model. In some variations, the fourth language model may be a general-purpose language model (e.g., GPT model). In some variations, the first dataset may be the same as the dataset generated in FIG. 8A via the dataset generator module 226d. Similarly, the second dataset may be the same as the dataset generated in FIG. 8B via the dataset generator module 226d.

At step 976, the method comprises evaluating the performance of one or more large language models based on the one or more assessment metrics obtained in step 972 and the first dataset and/or the second dataset obtained in step 974. The quality assessor module 226e can be configured to perform two types of evaluations – (i) individual assessment of one or more large language models; or (ii) comparative assessment of two or more large language models.

### Individual assessment

Individual assessment can comprise individual evaluation of one or more large language models. More specifically, individual assessment can comprise individually evaluating the ability of a large language model to perform a specific task given an input prompt. Put differently, the input prompt that is used to evaluate the performance of the large language model can be the original un-modified input prompt. However, the output that is used to evaluate the performance of the large language model may be generated responsive to the input prompt or responsive to the modified input prompt. Accordingly, for a given input prompt, the quality assessor module 226e can individually evaluate the performance of one or more large language models.

For instance, in some variations, the quality assessor module 226e can be configured to individually evaluate the fine-tuned custom language model (e.g., generated at step 756 in FIG. 7). That is, given an input prompt, the quality assessor module 226e can be configured to evaluate the ability of the fine-tuned custom language model to perform the specific task corresponding to the input prompt. The individual evaluation of the fine-tuned custom language model can be based on the one or more assessment metrics obtained at step 972 and an output from the fine-tuned custom language model obtained at step 974. As discussed above, the output from the fine-tuned custom model can be generated responsive to being provided with the modified input prompt. In some variations, the individual evaluation of the fine-tuned custom language model can be based on the one or more assessment metrics obtained at step 972 and the first dataset (e.g., dataset generated in FIG. 8A via the dataset generator module 226d) obtained at step 974. To evaluate the fine-tuned custom language model, the quality assessor module 226e can perform the following– (i) for each assessment metric of the one or more assessment metrics obtained at step 972: generate a score based on whether an output from the fine-tuned custom language model satisfies that assessment metric; and (ii) evaluate the performance of the fine-tuned custom language model based on the generated scores (for each of the assessment metrics). In variations in which the first dataset is used to evaluate the fine-tuned custom language model, the quality assessor module 226e can generate scores for each pair of the plurality of pairs of data in the first dataset.

In a similar manner, the quality assessor module 226e can be configured to individually evaluate the fourth language model as discussed above. For instance, as discussed above, the fourth language model may be a same model as the first language model. In some variations, the fourth language model may be a general-purpose language model (GPT). Given an input prompt, the quality assessor module 226e can be configured to evaluate the ability of the fourth language model to perform the specific task corresponding to the input prompt. The individual evaluation of the fourth language model can be based on the one or more assessment metrics obtained at step 972 and an output from the fourth language model obtained at step 974. As discussed above, the output from the fourth language model can be generated responsive to being provided with the input prompt. In some variations, the individual evaluation of the fourth language model can be based on the one or more assessment metrics obtained at step 972 and the second dataset (e.g., dataset generated in FIG. 8B via the dataset generator module 226d) obtained at step 974. To evaluate the fourth language model, the quality assessor module 226e can perform the following– (i) for each assessment metric of the one or more assessment metrics obtained at step 972: generate a score based on whether an output from the fourth language model satisfies that assessment metric; and (ii) evaluate the performance of the fourth language model based on the generated scores (for each of the assessment metrics). In variations in which the second dataset is used to evaluate the fourth language model, the quality assessor module 226e can generate scores for each pair of the plurality of pairs of data in the second dataset.

In some variations, the scores generated by the quality assessor module 226e for individually evaluating one or more large language models (e.g., fine-tuned custom language model, fourth language model, etc.) can be a numerical score. In such variations, the performance of the one or more language models can be evaluated based on a summation of the scores that are generated for each assessment metric and/or based on summation of scores that are generated for each pair of data in the dataset (e.g., first dataset or second dataset) that is used for evaluation.

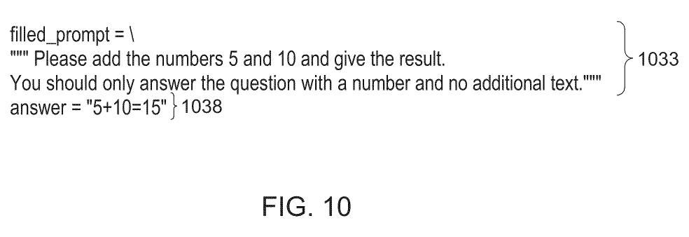

FIG. 10 illustrates an example output 1038 generated by a large language model such as for example, the fine-tuned custom language model or the fourth language model. The quality assessor module 226e can be configured to assess the output 1038 given that the input prompt is 1033. Put differently, the input prompt 1033 is the original un-modified input prompt. Given this input prompt 1033, the quality assessor module 226e can be configured to individually evaluate the performance of the fine-tuned custom language model and/or the fourth language model. Towards this end, the quality assessor module 226e obtains an output from fine-tuned custom language model and/or the fourth language model. In this example, consider that the example output 1038 is generated from the fine-tuned custom language model. In this scenario, as discussed above, to generate the output 1038, the input prompt 1033 can be modified via prompt modifier module 226b. The modified input prompt can be provided to the fine-tuned custom language model. Responsive to being provided with the modified input prompt, the custom-language model can generate the output 1038. As another example, consider that the example output 1038 is generated from the fourth language model. In this scenario, as discussed above, to generate the output 1038, the input prompt 1033 can be provided to the fourth language model. Responsive to being provided with the input prompt 1033, the fourth language model can generate the output 1038.

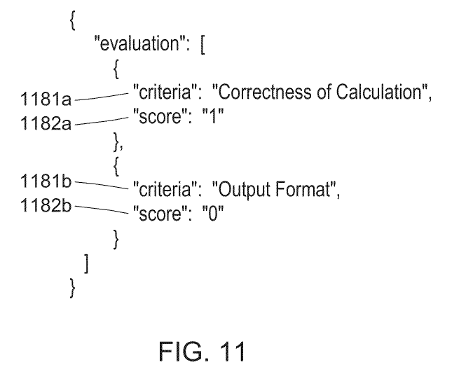

FIG. 11 illustrates example assessment metrics and example scores generated for these assessment metrics via the quality assessor module 226e. In FIG. 11, example assessment metrics that are obtained at the quality assessor module 226e include assessment metric 1181a and assessment metric 1181b. The quality assessor module 226e can evaluate the performance of a large language model based on these assessment metrics. For instance, in this example, quality assessor module 226e evaluates the performance of a large language model based on the output 1038 generated by the large language model and the assessment metrics 1181a and 1181b. For the assessment metric 1181a, the quality assessor module 226e assigns a score of 1182a. In this example, the score 1182a is “1”. By assigning the score “1”, the quality assessor module 226e signifies that the output 1038 satisfies the assessment metric 1181a. For the assessment metric 1181b, the quality assessor module 226e assigns a score of 1182b. In this example, the score 1182b is “0”. By assigning the score “0”, the quality assessor module 226e signifies that the output 1038 does not satisfy the assessment metric 1181b. In this manner, the quality assessor module 226e can assign a score for each assessment metric. The performance of the large language model can be evaluated based on the summation of the scores. In some variations, the quality assessor module 226e can determine a score for each output in a dataset (e.g., first dataset or second dataset). The performance of the large language module can be evaluated based on the summation of the scores.

### Comparative assessment

Comparative assessment can comprise evaluating a performance of one language model in comparison to a performance of another language model. For example, comparative assessment can comprise evaluating the performance of the fine-tuned custom language model by comparing the performance of the fine-tuned custom language model to the performance of the fourth language model described above. More specifically, comparative assessment can comprise evaluating the ability of the fine-tuned custom language model to perform a specific task by comparing the ability of the fine-tuned custom language model to the ability of the fourth language model to perform the specific task.

The quality assessor module 226e can be configured to perform the comparative assessment based on the input prompt. Put differently, the original un-modified input prompt can be used to perform the comparative assessment of one or more language models. That said, to perform the comparative assessment, two outputs would have to be compared. One of these outputs may be obtained responsive to providing the modified input prompt (i.e., generated by modifying the input prompt) to a language model and the other output may be obtained responsive to providing the input prompt to another language model. For example, the quality assessor module 226e can obtain the output from the fine-tuned custom language model that is generated responsive to the modified input prompt and the output from the fourth language model that is generated responsive to the input prompt. The output from the fine-tuned custom language model can be compared to the output from the fourth language model.

The quality assessor module 226e can compare the performance of the one or more language models based on one or more assessment metrics (e.g., assessment metrics obtained in step 972 in FIG. 9). In some variations, the quality assessor module 226e can perform comparative assessment based additionally on the input prompt and the first dataset (e.g., dataset generated in FIG. 8A via the dataset generator module) and the second dataset (e.g., dataset generated in FIG. 8B via the dataset generator module) that are obtained at step 974 in FIG. 9. Put differently, a first pair of data in the first dataset and a second pair of data in the second dataset can be identified based on the input prompt. That is, the first pair of data in the first dataset may be a pair that includes the given input prompt and similarly the second pair of data in the second dataset may be a pair that includes the same given input prompt. Once the pair of data from the first dataset and the second dataset are identified, the outputs of the first pair of data and the second pair of data can be compared so as to compare the performance of the fine-tuned custom language model and the fourth language model.

Accordingly, for a given input prompt, the quality assessor module 226e compares the output from the fine-tuned custom language model (e.g., generated responsive to the modified input prompt) and the output from the fourth language model (e.g., generated responsive to the input prompt). In some variations, the fourth language model can be any suitable language model that is considered to produce “good-enough” outputs to perform the specific task.

As discussed above, the quality assessor module 226e can compare the performance of the one or more language models based on one or more assessment metrics (e.g., assessment metrics obtained in step 972 in FIG. 9). In some variations, the quality assessor module 226e can be configured to determine a winner based on whether the output from the fine-tuned custom language model satisfies an assessment metric and on whether the output from the fourth language model satisfies that assessment metric. For example, consider that the quality assessor module 226e is evaluating using comparative assessment the performance of a fine-tuned custom language model for a given input prompt. For this given input prompt, the quality assessor module 226e can identify a first pair of data in the first dataset (e.g., dataset generated in FIG. 8A) that includes the input prompt. The quality assessor module 226e can also identify a second pair of data in the second dataset (e.g., dataset generated in FIG. 8B) that includes the input prompt. The quality assessor module 226e then compares the output in the first pair of data to the output in the second pair of data. As discussed above, the output in the first pair of data is generated responsive to providing the fine-tuned custom language model with the modified input prompt and the output in the second pair of data is generated responsive to providing the fourth language model with the input prompt.

Responsive to the output in the first pair of data satisfying an assessment metric and the output in the second pair of data not satisfying the assessment metric, the quality assessor module 226e determines the first pair of data as the winner. Similarly, responsive to the output in the first pair of data not satisfying an assessment metric and the output in the second pair of data satisfying the assessment metric, the quality assessor module 226e determines the second pair of data as the winner. Furthermore, responsive to the output in the first pair of data and the output in the second pair of data satisfying the assessment metric, the quality assessor module 226e determines a tie between the first pair of data and the second pair of data. In this manner, the quality assessor module 226e can grade (e.g., determine winners) outputs from the fine-tuned custom language model and the fourth language model. The quality assessor module can grade outputs from the first dataset and the second dataset for each corresponding input prompt. In some variations, the quality assessor module 226e can determine whether the fine-tuned custom language model is performing better than the fourth language model based on a cumulative grade for all the outputs in the first dataset and the second dataset.

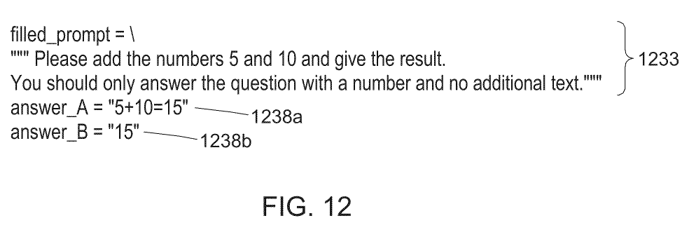

FIG. 12 illustrates example outputs 1238a and 1238b that are generated by two large language models, such as for example, the fine-tuned custom language model and the fourth language model. Given the input prompt 1233, the quality assessor module 226e can be configured to compare the outputs 1238a and 1238b. Put differently, the input prompt 1233 is the original un-modified input prompt. Given this input prompt 1233, the quality assessor module 226e can be configured to compare the performance of the fine-tuned custom language model and the fourth language model. One of the outputs 1238a or 1238b is generated responsive to the fine-tuned custom language model being provided with the modified input prompt (e.g., that has been modified via the prompt modifier 226b) while the other output is generated responsive to the fourth language model being provided with the input prompt 1233.

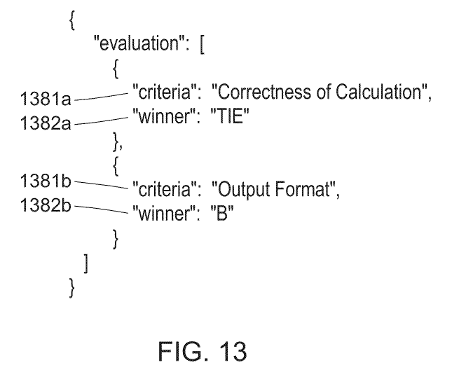

FIG. 13 illustrates example assessment metrics and example winners determined via the quality assessor module 226e. In FIG. 13, example assessment metrics that are obtained by the quality assessor module 226e include assessment metric 1381a and assessment metric 1381b. For the assessment metric 1381a, the quality assessor module 226e compares output 1238a and 1238b. In this example, both the outputs 1238a and 1238b satisfies the assessment metric 1381a. Accordingly, the quality assessor module 226e determines a tie between the pair of data that includes the output 1238a and the pair of data that includes the output 1238b. Similarly, for assessment metric 1381b, the quality assessor module 226e compares the output 1238a and 1238b. In this example, the quality assessor module 226e determines that output 1238b satisfies the assessment metric 1381b but the output 1238a does not satisfy the assessment metric 1381b. Accordingly, for this assessment metric the quality assessor module determines that the pair of data that includes the output 1238b is the winner. In this manner, by comparing the outputs from two language models for each assessment metric, the quality assessor module 226e can determine the language model that performs the specific task better than the other language model.

Therefore, as described herein, the quality assessor module 226e can be configured to individually evaluate one or more language models. For example, the quality assessor module 226e can be configured to individually evaluate the fine-tuned custom language model and/or the fourth language model. In some variations, the quality assessor module 226e can be configured to generate one or more scores based on the individual evaluation of the one or more language models. In such variations, the score(s) can be transmitted to the user interface 222. Additionally or alternatively, the score(s) may be used by the quality assessor module 226e to generate a report (e.g., human-readable report). For instance, the report may include the score(s) associated with the one or more language models or the individual performance of the one or more language models. The report may be transmitted to a human (e.g., via the user interface 222). The human can make choices relating to the language models based on their individual evaluation.

In a similar manner, the quality assessor module 226e can be configured to perform comparative assessment of two or more language models. For example, the quality assessor module 226e can be configured to compare the performance of the fine-tuned language model and the fourth language model. In some variations, the quality assessor module 226e can assign one or more grades (e.g., based on determining winners for each assessment metrics) to the fine-tuned language model and the fourth language model. In such variations, the grade(s) can be transmitted to the user interface 222. Additionally or alternatively, the grade(s) may be used by the quality assessor module 226e to generate a report (e.g., a human-readable report). For instance, the report may include the grade(s) associated with each of the language models and an identification of which of these language models is better performing. The report may be transmitted to a human (e.g., via the user interface 222). The human can make choices relating to the language models based on this comparative assessment.

In some variations, the quality assessor module 226e can also output the runtime performance evaluation (e.g., power usage, the generation speed, the memory requirement, etc.) of the one or more language models based on their individual assessment and/or comparative assessment. This runtime performance evaluation can be transmitted to the user interface 222. In some variations, the runtime performance evaluation can be included in the human-readable report that may be generated by the quality assessor module 226e.

In some variations, the output(s) from the quality assessor module 226e can facilitate decisions relating to deployment-ability of the one or more language models. For example, the individual assessment and/or the comparative assessment described herein can provide an insight to the performance of the one or more language models. Based on these assessments, a decision can be made on whether a language model is performing well-enough that it can be deployed or whether the language model may need further fine-tuning and/or further generation of datasets described herein before the language model can be deployed.

In this manner, the system 100 described herein can a) automatically generate assessment metrics, b) automatically fine-tune a custom large language model, c) automatically generate one or more datasets to be evaluated, and/or d) automatically evaluate one or more language models. It should be readily understood that while the controller 224 can implement all of the modules described herein to perform all the functions of the system 100, the controller 224 may also implement some of the modules to perform only some of the functions of the system 100. As a non-limiting example, the controller 224 can simply implement the assessment generator module 226a to automatically generate assessment metric(s) to evaluate one or more language models. As another non-limiting example, the controller 224 can simply implement the prompt modifier module 226b and the training module 226c to fine-tune the custom language model. Furthermore, it should be readily understood that while the controller can implement a module in its entirety, in some variations, the controller 224 may implement only a portion of a module. As a non-limiting example, the controller 224 can implement the assessment generator module 226a, a portion of the dataset generator module 226d (e.g., the method 800B described in FIG. 8B), and a portion of the quality assessor module 226e (e.g., performing individual assessment) to evaluate the performance of the fourth language model. As another non-limiting example, the controller 224 can implement, the assessment generator module 226a, the prompt-modifier module 226b, the training module 226c, a portion of the dataset generator module 226d (e.g., the method 800A described in FIG. 1A), and a portion of the quality assessor module 226e (e.g., performing individual assessment) to evaluate the performance of the fine-tuned custom language model.

### EXAMPLE METHOD

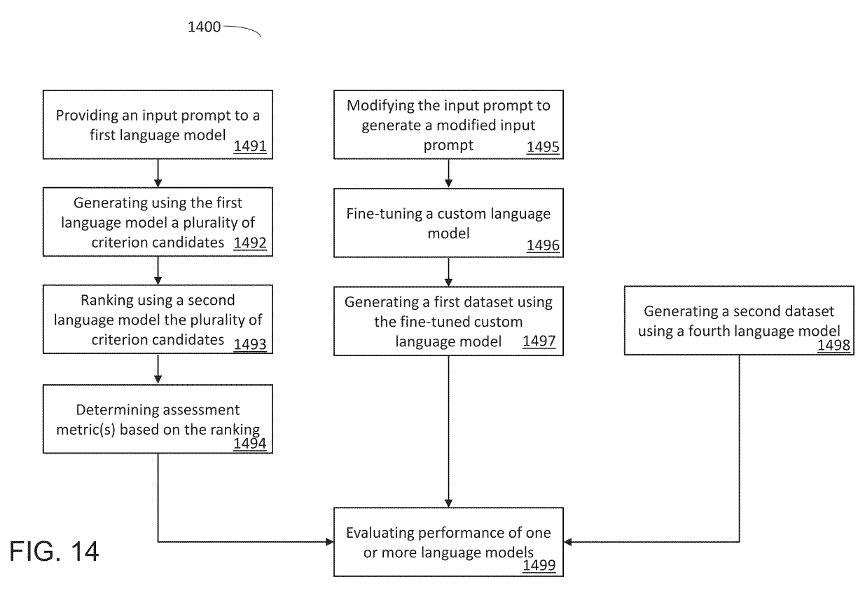

FIG. 14 illustrates an example variation of a method 1400 for generating assessment metric(s) for evaluating a large language model, fine-tuning a large language model, and evaluating performance of a large language model.

### Generating Assessment Metrics

Steps 1491-1494 of FIG. 14 depict an example method for generating one or more assessment metrics for evaluating one or more large language models. The assessment metrics can be generated via a module such as for example, the assessment metric generator module 226a described in FIG. 2. As discussed above, for a given input prompt, the one or more assessment metrics can evaluate a large language model’s ability to perform a specific task.

At step 1491, the method comprises providing as input an input prompt to a first language model. In some variations, the first language model can be a general-purpose language model, such as for example, a generative pre-trained transformer (GPT) model (e.g., ChatGPT that was developed by OpenAI™). The input prompt can be configured to guide a language model (e.g., the one or more language models being evaluated) to perform a specific task. In some variations, the input prompt may be accompanied with and/or may include input data to provide context to the language model (e.g., the one or more language models being evaluated) to perform the specific task. Consider an example in which a language model (e.g., the one or more language models being evaluated) is to perform a task of adding two numbers. In this example, the input prompt can be “Please add numbers {{Number 1}} and {{Number 2}} and give the result. You should only answer the question with a number and no additional text”. The input data can be “Number 1: 5; Number 2: 10”.

At 1492, the method comprises generating, using the first language model and based at least in part on the input prompt, a plurality of criterion candidates for evaluating the one or more large language models. Put differently, given the input prompt, the first language model (e.g., general-purpose language model) can generate a plurality of criterion candidates to evaluate outputs from the one or more language models. The plurality of criterion candidates can be configured to evaluate how well the one or more large language models are performing the specific task. For instance, in the above example, the plurality of criterion candidates generated by the first language model can include criterions such as “check if the language model has correctly added the provided numbers”, “check if the output is a single number without any additional text”, etc.

At step 1493, the method comprises ranking, using a second language model, the plurality of criterion candidates. In some variations, the second language model is a same model as the first language model. In some variations, the second language model can be a general-purpose language model, such as for example, a generative pre-trained transformer (GPT) model (e.g., ChatGPT that was developed by OpenAI™). The ranking can be performed more than one time. As a non-limiting example, at step 1493, the method can comprise ranking, using the second language model, the plurality of criterion candidates a first time, thereby producing a first set of ranks, and after producing the first set of ranks, ranking, using the second language model , the plurality of criterion candidates a second time after the first time, thereby producing a second set of ranks. In a similar manner, the method can comprise, ranking, using the second language model, the plurality of candidates any suitable number of times to produce any suitable number of sets of ranks. In some variations, the second language model and the first language model can be a same model. In some variations, the second language model can be a general-purpose generative language model. In some variations, the ranking can be based on at least one of a clarity, a conciseness, and an objectiveness of each of the plurality of criterion candidates. The ranking can be performed more than one time to mitigate stochastic nature of the second language model. In particular, generative language models may not necessarily be deterministic. Therefore, to improve accuracy of the assessment metric(s), the criterion candidates can be ranked more than one time.

At step 1494, the method comprises determining one or more assessment metrics based on the ranks and/or the sets of ranks produced at step 1493. In some variations, the one or more assessment metrics can be determined based on an average of the ranks produced at step 1493.

### Fine-tuning a custom language model

Steps 1495-1496 of FIG. 14 depict an example method for fine-tuning a custom language model. More specifically, the one or more language models to be evaluated can comprise a custom language model. Steps 1495-1496 depict the steps for fine-tuning this custom language model. In some variations, fine-tuning the custom language model may include generating a training dataset using the input prompt. The input prompt is provided to a general-purpose language model that generates output in response to the input prompt. At step 1495, the method comprises automatically modifying the input prompt to generate a modified input prompt. In variations in which the training dataset is generated, step 1495 may be implemented after the generation of the training dataset. The modified input prompt can be generated via a module, such as for example, prompt modifier module 226b described in FIG. 2. In some variations, modifying the input prompt can include eliminating unnecessary instructions from the input prompt and/or eliminating unnecessary data from the input data. For example, consider the input prompt “Please add numbers {{Number 1}} and {{Number 2}} and give the result. You should only answer the question with a number and no additional text” that is accompanied with and/or includes the input data “Number 1: 5; Number 2: 10”. In this example, the input prompt can be modified to eliminate unnecessary instructions and/or data to generate the modified input prompt - “5+10”.

The modified input prompt can be configured to improve the token efficiency of the custom language model. After producing the modified input prompt, the method at step 1496 comprises fine-tuning , using the modified input prompt, the custom language model to produce a fine-tuned custom language model. The fine-tuning can be performed via a module such as for example, training module 226c described in FIG. 2.

### Generating datasets for evaluating large language models

The dataset for evaluating the one or more large language models can be generated via a module such as for example, dataset generator module 226d described in FIG. 2. At step 1497, the method comprises generating a first dataset. More specifically, after fine-tuning the custom language model, the fine-tuned custom language model can generate a first dataset. The first dataset can include an output from the fine-tuned custom language model that is generated in response to the fine-tuned custom language model being provided with the modified input prompt. In some variations, the first dataset can comprise a plurality of pairs of data. For instance, the first dataset can comprise a plurality of pairs of first data. At least one pair of these pairs of first data can comprise: (1) the output that is generated in response to the fine-tuned custom language model being provided with the modified input prompt; and (2) the input prompt. In variations in which the training dataset is generated, the first dataset may be the training dataset that is modified using the modified input prompt.

At step 1498, the method comprises generating a second dataset. More specifically, the one or more language models to be evaluated can comprise a fourth language model. The fourth language model can be used to generate the second dataset. In some variations, the fourth language model can be a same model as the first language model. In some variations, the fourth language model can be a general-purpose language model, such as for example, a generative pre-trained transformer (GPT) model (e.g., ChatGPT that was developed by OpenAI™).

The second dataset can include an output from the fourth language model that is generated in response to the fourth language model being provided with the input prompt. In some variations, the dataset can comprise a plurality of pairs of data. For instance, the second dataset can comprise a plurality of pairs of second data. At least one pair of these pairs of second data can comprise: (1) the output that is generated in response to the fourth language model being provided with the input prompt; and (2) the input prompt.

### Evaluating performance

The performance of the one or more language models can be evaluated via a module such as for example, quality assessor module 226e described in FIG. 2. At 1499, the method can include evaluating the performance of one or more large language models based on the assessment metric(s) and the input prompt. The method can perform individual assessment of the one or more large language models or comparative assessment between one or more large language models.

For individual assessment, evaluating the performance of the fine-tuned custom language model can include – (i)for each assessment metric: generating a score based on whether an output from the fine-tuned custom language model satisfies that assessment metric, and (ii) evaluating the performance of the fine-tuned custom language model based on the generated scores. In some variations, the score can be a numerical value. In such variations, the performance of the fine-tuned custom language model can be evaluated based on a summation of the scores that are generated for each assessment metric. Similarly, evaluating the performance of the fourth language model can include – (i) for each assessment metric: generating a score based on whether the output from the fourth language model satisfies that assessment metric; and (ii) evaluating the performance of the fourth language model based on the generated scores. In some variations, the score can be a numerical value. In such variations, the performance of the fourth language model can be evaluated based on a summation of the scores that are generated for each assessment metric.

For comparative assessment, the method 1400 can further include comparing an output from the fourth language model and an output from the fine-tuned custom language model. As discussed above, the output from the fourth language model can be generated in response to providing the input prompt to the fourth language model. The output from the fine-tuned custom language model can be generated in response to providing the modified input prompt to the fine-tuned custom language model. The method 1400 can comprise evaluating the performance of the fine-tuned custom language model and/or the fourth language model based on this comparison.

In some variations, comparative assessment can further include determining a winner based on whether the output from the fine-tuned custom language model satisfies an assessment metric or on whether the output from the fourth language model satisfies the assessment metric. In some variations, determining the winner can further comprise: (a) responsive to the output from the fine-tuned custom language model satisfying the assessment metric and the output from the fourth language model not satisfying the assessment metric, determining the corresponding pair of the first dataset as a winner; (b) responsive to the output from the fine-tuned custom language model not satisfying the an assessment metric and the output from the fourth language model satisfying the assessment metric, determining the corresponding pair of the second dataset as the winner; and (c) responsive to the output from the fine-tuned custom language model satisfying the an assessment metric and the output from the fourth language model satisfying the assessment metric, determining a tie between the corresponding pair of the first dataset and the corresponding pair of the second dataset.

In some variations, the method 1400 can include outputting an evaluation report based on the evaluation of the performance of the one or more language models. In some variations, the method 1400 can further include outputting a decision to deploy the one or more language models based on the evaluation of the performance of the one or more language models.

In this manner, the technology described herein can facilitate end-to-end automation of generating assessment metrics, fine-tuning a language model, and evaluating one or more language models. As discussed above, existing methods require human intervention for generating datasets, generating assessment metrics, or fine-tuning a language model. The requirement for human-intervention and/or human supervision can be reduced or altogether eliminated by the technology described herein.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to explain the principles of the invention and its practical applications, they thereby enable others skilled in the art to utilize the invention and various embodiments with various modifications as are suited to the particular use contemplated. It is intended that the following claims and their equivalents define the scope of the invention.

1. A computer-implemented method for automated assessment of one or more language models, the method comprising:
generating, using a first language model and based at least in part on an input prompt, a plurality of criterion candidates for evaluating an output from the one or more language models, wherein the first language model is a general-purpose generative language model;
ranking, using a second language model, the plurality of criterion candidates a first time, thereby producing a first set of ranks;
after producing the first set of ranks, ranking, using the second language model, the plurality of criterion candidates a second time after the first time, thereby producing a second set of ranks;
determining, based on the first set of ranks and the second set of ranks, at least one assessment metric to evaluate the output from the one or more language models; and
evaluating, based at least in part on the at least one assessment metric, a performance of the one or more language models.

2. The computer-implemented method of claim 1, wherein the one or more language models comprises a third language model, the method further comprising:
automatically modifying the input prompt to generate a modified input prompt, the modified input prompt being configured to improve token efficiency of the third language model;
fine-tuning, using the modified input prompt, the third language model to produce a fine-tuned third language model, wherein the third language model is a specialized model that is trained to perform a specific task; and
evaluating, based on the at least one assessment metric, a performance of the fine-tuned third language model.

3. The computer-implemented method of claim 2, wherein the at least one assessment metric comprises a plurality of assessment metrics, and wherein evaluating the performance further includes:
for each assessment metric of the plurality of assessment metrics:
generating a score based on whether an output from the fine-tuned third language model satisfies the assessment metric; and
evaluating the performance of the fine-tuned third language model based on the
generated scores.

4. The computer-implemented method of claim 2, wherein the one or more language models further comprise a fourth language model, the method further comprising:
comparing an output from the fourth language model and an output from the fine-tuned third language model, wherein the output from the fourth language model is generated in response to providing the input prompt to the fourth language model, and wherein the output from the fine-tuned third language model is generated in response to providing the modified input prompt to the fine-tuned third language model; and
evaluating the performance of the fine-tuned third language model based on the comparison.

5. The computer-implemented method of claim 4, wherein the method further includes:
determining a winner based on whether the output from the fine-tuned third language model satisfies the at least one assessment metric or on whether the output from the fourth language model satisfies the at least one assessment metric; and
evaluating the performance of the fine-tuned third language model and the fourth language model based on the determined winner.

6. The computer-implemented method of claim 4, wherein the first language model and the fourth language model are a same model.

7. The computer-implemented method of claim 1, further comprising outputting a decision to deploy the one or more language models based on the evaluation of the performance of the one or more language models.

8. The computer-implemented method of claim 1, further comprising:
after producing the second set of ranks, ranking, using the second language model, the plurality of criterion candidates a third time after the second time, thereby producing a third set of ranks; and
determining the at least one assessment metric based on the first set of ranks, the second set of ranks, and the third set of ranks.

9. A system for automated assessment of one or more language models, the system comprising:
at least one controller configured to execute:
an assessment metric generator module, the assessment metric generator module being configured to:
generate, using a first language model and based at least in part on an input prompt, a plurality of criterion candidates for evaluating an output from the one or more language models, wherein the first language model is a general-purpose generative language model,
rank, using a second language model, the plurality of criterion candidates a first time, thereby producing a first set of ranks,
after producing the first set of ranks, rank, using the second language model, the plurality of criterion candidates a second time after the first time, thereby producing a second set of ranks, and
determine, based on the first set of ranks and the second set of ranks, at least one assessment metric to evaluate the output from the one or more language models; and
a quality assessor module to evaluate, based at least in part on the at least one assessment metric, a performance of the one or more language models.

10. The system of claim 9, wherein the one or more language models comprises a third language model, and wherein the at least one controller is further configured to execute:
a prompt modifier module to automatically modify the input prompt to generate a modified input prompt, the modified input prompt being configured to improve token efficiency of the third language model;
a training module to fine-tune, using the modified input prompt, the third language model to produce a fine-tuned third language model, wherein the third language model is a specialized model that is trained to perform a specific task; and
the quality assessor module to evaluate, based on the at least one assessment metric, a performance of the fine-tuned third language model.

11. The system of claim 10, wherein the at least one assessment metric comprises a plurality of assessment metrics, and
wherein the assessment metric generator module is further configured to:
for each assessment metric of the plurality of assessment metrics:
generate a score based on whether an output from the fine-tuned third language model satisfies the assessment metric; and
wherein the quality assessor module is further configured to evaluate the performance of the fine-tuned third language model based on the generated scores.

12. The system of claim 10, wherein the one or more language models further comprise a fourth language model, and wherein the quality assessor module is further configured to:
compare an output from the fourth language model and an output from the fine-tuned third language model, wherein the output from the fourth language model is generated in response to providing the input prompt to the fourth language model, and wherein the output from the fine-tuned third language model is generated in response to providing the modified input prompt to the fine-tuned third language model; and
evaluate the performance of the fine-tuned third language model based on the comparison.

13. The system of claim 12, wherein the quality assessor module is further configured to:
determine a winner based on whether the output from the fine-tuned third language model satisfies the at least one assessment metric or on whether the output from the fourth language model satisfies the at least one assessment metric; and
evaluate the performance of the fine-tuned third language model and the fourth language model based on the determined winner.

14. The system of claim 12, wherein the first language model and the fourth language model are a same model.

15. The system of claim 9, wherein the quality assessor module is further configured to output a decision to deploy the one or more language models based on the evaluation of the performance of the one or more language models.

16. The system of claim 9, wherein the assessment metric generator module is further configured to:
after producing the second set of ranks, rank, using the second language model, the plurality of criterion candidates a third time after the second time, thereby producing a third set of ranks; and
determine the at least one assessment metric based on the first set of ranks, the second set of ranks, and the third set of ranks.

17. A non-transitory computer readable storage medium comprising computer readable code configured to cause a computer to perform a dialogue method comprising the following operations:
generating, using a first language model and based at least in part on an input prompt, a plurality of criterion candidates for evaluating an output from the one or more language models, wherein the first language model is a general-purpose generative language model;
ranking, using a second language model, the plurality of criterion candidates a first time, thereby producing a first set of ranks;
after producing the first set of ranks, ranking, using the second language model, the plurality of criterion candidates a second time after the first time, thereby producing a second set of ranks;
determining, based on the first set of ranks and the second set of ranks, at least one assessment metric to evaluate the output from the one or more language models; and
evaluating, based at least in part on the at least one assessment metric, a performance of the one or more language models.

18. The non-transitory computer readable storage medium of claim 17, comprising further computer readable code to cause a computer to perform a dialogue method comprising the following operations:
automatically modifying the input prompt to generate a modified input prompt, the modified input prompt being configured to improve token efficiency of the third language model;
fine-tuning, using the modified input prompt, the third language model to produce a fine-tuned third language model, wherein the third language model is a specialized model that is trained to perform a specific task; and
evaluating, based on the at least one assessment metric, a performance of the fine-tuned third language model.
